(19) United States
(12) Patent Application Publication
(10) Pub. No.: US 2025/0263017 A1
(43) Pub. Date: Aug. 21, 2025

(54) SYSTEM FOR COVERING A MOTOR VEHICLE LUGGAGE COMPARTMENT

(71) Applicant: TREVES PRODUCTS,SERVICES & INNOVATION, Issy-Les-Moulineaux (FR)

(72) Inventors: Eric BRILLON, Issy-Les-Moulineaux (FR); Laurent CROCHET, Issy-Les-Moulineaux (FR)

(21) Appl. No.: 18/856,629

(22) PCT Filed: Apr. 13, 2023
(86) PCT No.: PCT/EP2023/059693

§ 371 Date: Oct. 14, 2024

(30) Foreign Application Priority Data
Apr. 14, 2022 (FR) 2203484

(51) Int. Cl. B60R 5/04

(52) U.S. Cl. CPC B60R 5/045

(57) ABSTRACT

The invention relates to a system (1) for covering a motor vehicle luggage compartment, said system comprising a shelf (3) comprising a socket (5) provided with a plurality of power supply terminals (7) and a trim (8) provided with a reciprocal socket (9) comprising a plurality of reciprocal terminals (10), a terminal (5)-or a reciprocal terminal (9), respectively—being in the form of a blade, a reciprocal terminal (9)—or a terminal (5), respectively—being in the form of a flared clamp enabling said terminal—or said reciprocal terminal, respectively—to be inserted so as to be squeezed between said branches, said sockets, once connected to one another, being able to slide with a minimum transverse clearance of 5 mm while remaining connected.

The invention relates to a system for covering a motor vehicle luggage compartment.

A system for covering a luggage compartment of a motor vehicle is known, said system comprising:
an assembly for covering said compartment, said assembly comprising a shelf removable by vertical translation and an electrical device, said shelf comprising a power supply socket for said device disposed along one of its lateral edges, said socket being provided with a plurality of power supply terminals for said device,
two side trims of said compartment receiving said shelf, one of said trims being provided with a reciprocal socket for receiving said socket, said reciprocal socket being provided with a plurality of reciprocal terminals for receiving each of said terminals, the connection of said terminals and reciprocal terminals being made by mounting said shelf on said trims.

With such an arrangement, it can be difficult to ensure an efficient connection between the sockets, due to the transverse dispersions that can occur in the positioning of the shelf in relation to its nominal position.

The aim of the invention is to overcome this drawback.

To this end, the invention proposes a system for covering a motor vehicle luggage compartment, said system comprising:
an assembly for covering said compartment, said assembly comprising a shelf removable by vertical translation and an electrical device, said shelf comprising a power supply socket for said device disposed along one of its lateral edges, said socket being provided with a plurality of power supply terminals for said device,
two side trims of said compartment receiving said shelf, one of said trims being provided with a reciprocal socket for receiving said socket, said reciprocal socket being provided with a plurality of reciprocal terminals for receiving each of said terminals, the connection of said terminals and reciprocal terminals being made by mounting said shelf on said trims,

said system also having the following features:
a terminal—or respectively a reciprocal terminal—is in the form of a blade extending in a transverse vertical plane, a reciprocal terminal—or respectively a terminal—being in the form of a spring-loaded metal clamp defining a vertically opening aperture, said clamp comprising two branches resiliently biased towards each other, the end portions of said branches diverging from one another upon directing towards their free ends, so as to define a flared shape enabling said terminal—or said reciprocal terminal, respectively—to be inserted and squeezed between said branches,
said sockets, once connected to one another, can slide with a minimum transverse clearance of 5 mm, while remaining connected, so as to allow an absorption of transverse positioning tolerances of said shelf with respect to its nominal position, while ensuring power supply to said device.

In this description, the terms positioning in space (top, longitudinal, transverse, lateral, front, rear, vertical, bottom, etc.) are used with reference to the system arranged in the vehicle.

With the proposed arrangement, the shelf can be positioned transversely offset from its nominal position, while maintaining the connection between the sockets to guarantee the power supply to the electrical device.

Further features and advantages of the invention will become apparent from the following description, made with reference to the attached figures, in which:

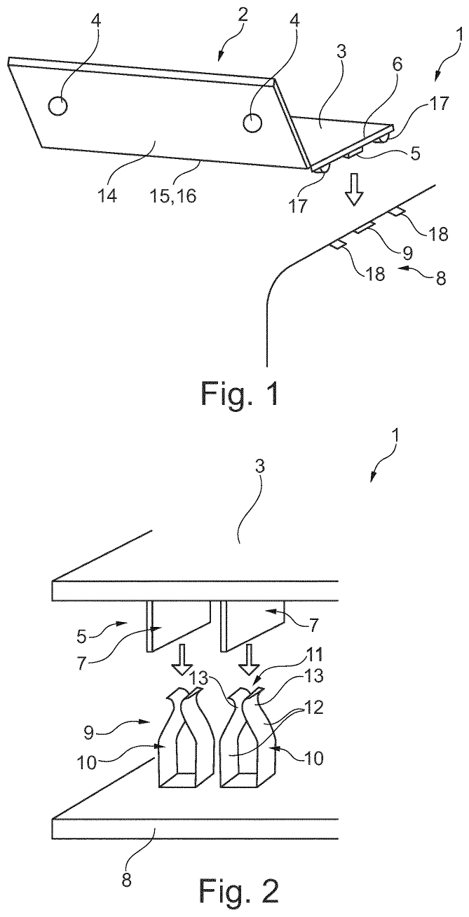

FIG. 1 is a partial perspective schematic view of a system according to one embodiment,

FIG. 2 is a schematic, partial perspective detail view of a socket and a reciprocal socket that are not connected to each other,

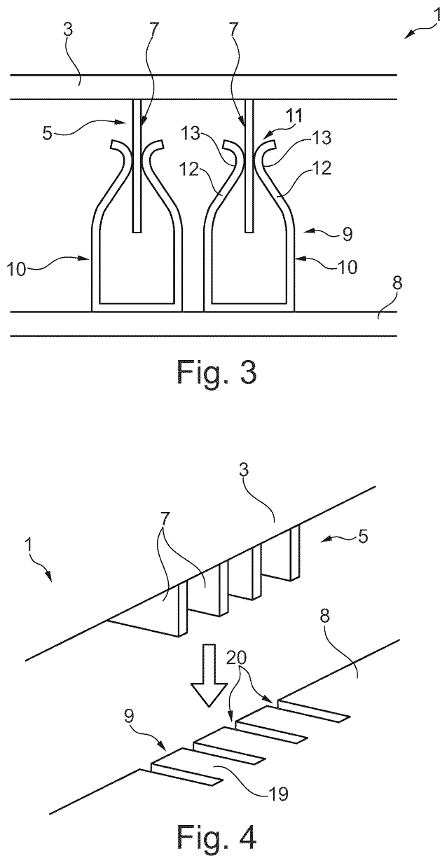

FIG. 3 is a schematic vertical partial longitudinal section detail view of a socket and a reciprocal socket connected to each other,

FIG. 4 is a schematic, partial perspective detail view of an assembly integrated in a vehicle according to one embodiment, with the shelf being mounted on the side trims of the luggage compartment.

With reference to the figures, a system 1 for covering a motor vehicle luggage compartment is described, said system comprising:
an assembly 2 for covering said compartment, said assembly comprising a shelf 3 removable by vertical translation and an electrical device 4, said shelf comprising a power supply socket 5 for said device arranged along one of its lateral edges 6, said socket being provided with a plurality of power supply terminals 7 for said device,
two side trims 8 of said compartment receiving said shelf, one of said trims being provided with a reciprocal socket 9 for receiving said socket, said reciprocal socket being provided with a plurality of reciprocal terminals 10 for receiving each of said terminals, the connection of said terminals and reciprocal terminals being made by mounting said shelf on said trims,

said system also having the following features:
a terminal 7, according to the embodiment shown, —or a reciprocal terminal 10, respectively, according to an embodiment not shown—is in the form of a blade extending in a transverse vertical plane, a reciprocal terminal 10, according to the embodiment shown, —or a terminal 7, respectively, according to an embodiment not shown—being in the form of a spring-loaded metal clamp defining a vertically opening aperture 11 (upwards according to the embodiment shown), said clamp comprising two branches 12 resiliently biased towards one another, the end portions 13 of said branches diverging from one another upon directing towards their free ends, so as to define a flared shape enabling said terminal—or said reciprocal terminal, respectively—to be inserted so as to be squeezed between said branches,
said sockets, once connected to one another, can slide with a minimum transverse clearance of 5 mm, while remaining connected, so as to allow absorption of transverse positioning tolerances of said shelf with respect to its nominal position, while ensuring power supply to said device.

According to the embodiment shown, the assembly 2 also includes a flap 14 located behind the shelf 3, the front edge 15 of said flap being rotatably mounted along the rear edge 16 of said shelf, so as to allow access to the luggage compartment by rotating said flap upwards.

As shown, the electrical device 4 is mounted on the flap 14, here below said flap.

In one embodiment, the electrical device 4 is in the form of an electrodynamic transducer, and its attachment to the flap 14 enables sound waves to be propagated using said flap as a radiating surface.

According to the embodiment shown, the shelf 3 is provided with means 17 for interlocking onto reciprocal means 18 provided on the side trims 8, so as to enable it to be fixed onto said trims and the correct longitudinal positioning of the socket 5 with respect to the reciprocal socket 9 during the mounting of said shelf.

According to the embodiment shown, the socket provided with clamps (the reciprocal socket 9 according to the embodiment shown) is protected by a wall 19 coming from the part supporting it (the trim 8 according to the embodiment shown), said wall being provided with slots 20 for inserting the blades into said clamps.

According to one embodiment, the socket provided with clamps (the reciprocal socket 9 according to the embodiment shown) is removably mounted (by interlocking, screwing, etc.) on the part supporting it (the trim 8 according to the embodiment shown), which makes it possible to equip or not equip a vehicle of a given model with an electrical device 4 according to its range level.

Not shown, the blade-equipped socket (the socket 5 according to the embodiment shown) can be fitted with a removable cover to protect said blades when the assembly 2 is disassembled from the trims 8.

In particular, the cover can be spring-mounted and have a surface that cooperates with a reciprocal surface of the shelf 3 to retract when said shelf is mounted on the trims 8.

In a non-represented embodiment, the socket 5 is connected to the electrical device 4 by cables which are inserted into a trench provided in the shelf 3, said trench being closed by a layer of covering material, for example non-woven or carpet-based.

In one embodiment, when the assembly comprises a flap 14, the cables are also inserted into a trench provided in said flap, said trench being closed by a layer of covering material, for example non-woven or carpet-based.

1. System (1) for covering a motor vehicle luggage compartment, said system comprising:
an assembly (2) for covering said compartment, said assembly comprising a shelf (3) removable by vertical translation and an electrical device (4), said shelf comprising a power supply socket (5) for said device disposed along one of its lateral edges (6), said socket being provided with a plurality of power supply terminals (7) for said device,
two side trims (8) of said compartment receiving said shelf, one of said trims being provided with a reciprocal socket (9) for receiving said socket, said reciprocal socket being provided with a plurality of reciprocal terminals (10) for receiving each of said terminals, the connection of said terminals and reciprocal terminals being made by mounting said shelf on said trims,
said system being characterized in that:
a terminal (5)—or a reciprocal terminal (9), respectively—is in the form of a blade extending in a transverse vertical plane, a reciprocal terminal (9)—or a terminal (5), respectively—being in the form of a spring-loaded metal clamp defining a vertically opening aperture (11), said clamp comprising two branches (12) resiliently biased towards one another, the end portions (13) of said branches diverging from one another upon directing towards their free ends, so as to define a flared shape enabling said terminal—or said reciprocal terminal, respectively—to be inserted so as to be squeezed between said branches,
said sockets, once connected to one another, can slide with a minimum transverse clearance of 5 mm, while remaining connected, so as to allow absorption of transverse positioning tolerances of said shelf with respect to its nominal position, while ensuring power supply to said device.

2. A system as claimed in claim 1, characterized in that the assembly (2) further comprises a flap (14) disposed behind the shelf (3), the front edge (15) of said flap being rotatably mounted along the rear edge (16) of said shelf, so as to allow access to the luggage compartment by rotating said flap upwards.

3. System according to claim 1, characterized in that the electrical device (4) is mounted on the flap (14).

4. System according to claim 1, characterized in that the electrical device (4) is in the form of an electrodynamic transducer.

5. System according to claim 1, characterized in that the shelf (3) is provided with means (17) for interlocking onto reciprocal means (18) provided on the side trims (8), so as to enable it to be fixed onto said trims and the correct longitudinal positioning of the socket (5) with respect to the reciprocal socket (9) during the mounting of said shelf.

6. System according to claim 1, characterized in that the socket provided with clamps (9) is protected by a wall (19) coming from the supporting part (8), said wall being provided with slots (20) for inserting the blades into said clamps.

7. System according to claim 1, characterized in that the socket provided with clamps (9) is removably mounted on the supporting part (8).

8. System according to claim 1, characterized in that the socket provided with blades (5) is provided with a removable cover to protect said blades when the assembly (2) is disassembled from the trims (8).

9. System according to claim 1, characterized in that the socket (5) is connected to the electrical device (4) by cables which fit into a trench provided in the shelf (3), said trench being closed by a layer of covering material.

10. System according to claim 3, characterized in that the cables are also inserted into a trench provided in the flap (14), said trench being closed by a layer of covering material.
